(19) United States
(12) Patent Application Publication
(10) Pub. No.: US 2009/0019900 A1
(43) Pub. Date: Jan. 22, 2009

(54) Connecting Rod Style Lock Assembly for Fingerprint Safekeeping Box

(76) Inventor: Hao Min, Nanjing (CN)

Correspondence Address: GLOBAL IP SERVICES, 7285 W. Eagle Court, Winton, CA, 95388, US

(21) Appl. No.: 12/173,302

(22) Filed: Jul. 15, 2008

(30) Foreign Application Priority Data
Jul. 19, 2007 (CN) 200720040734.8

(51) Int. Cl. E05B 65/52

(52) U.S. Cl. 70/91

(57) ABSTRACT

A connecting rod style lock assembly for fingerprint safekeeping box comprises a bracket, a lock with lock cam pivot, a biasing means is connected with the lock cam for turning the lock cam to open position, a lock bar is embed in the lock groove to make the lock cam without turn, a lock buckle is fixed on the door of a safekeeping box, an actuator device includes a crankshaft and a connecting rod, one end of the lock bar is connected with the connecting rod in rotary connection. When closing door the lock buckle pushes the lock cam turn to lock the door, when opening door, the motor drives the crankshaft turn to pull the connecting rod pulling the lock bar out off the lock groove of the lock cam, then the biasing means forces the lock cam turn to unlock the door. The assembly is simple and small, the effective inner space of the Safekeeping Box is increased, the cost for the product is reduced greatly, and the assembly can be formed a complete set with all kind of fingerprint locks.

### CROSS REFERENCE TO RELATED PATENT APPLICATION

This application claims the priority of the Chinese patent application No. 200720040734.8 with a filing date of Jul. 19, 2007, which is incorporated herein by reference.

### FIELD OF THE INVENTION

The present invention relates to a kind of door lock. Particularly, relates to a connecting rod style lock assembly used for fingerprint safekeeping boxes. More particularly, relates to a lock assembly driven by connecting rod for fingerprint safekeeping boxes.

### BACKGROUND OF THE INVENTION

The lock assembly for fingerprint safekeeping boxes in market always uses ratch device driven by a motor to open lock. The ratch device has many disadvantages, such as complex structure, inconvenience in manufacture, assembly and maintenance. Furthermore, the ratch device is bulk, occupies a big space in a safekeeping box. The inventor made an improvement for it. A motor plus cord driving device is used to replace the ratch device, which is illustrated in the FIG. 1. The motor 28 turn to coil the cord 30 then to pull the lock bar out off the lock groove. However, the motor plus cord driving device still has many disadvantages, the cord is easy break off as the cord tires after many times of pull. Normally, the cord has a life of about 2000 times of pull; this kind of life cannot be satisfied for the operation of the safekeeping box. In the meantime, the motor plus cord device needs a powerful motor for pulling the cord; it causes the life of batteries for the motor short.

### SUMMARY OF THE INVENTION

In view of the preceding, it is an object of the invention to provide a connecting rod style lock assembly to instead the ratch device style rock assembly for fingerprint safekeeping box to overcome the disadvantages of the old device, such as bulk, complex structure, inconvenience in manufacture etc.

In this invention a connecting rod style lock assembly comprises a base, a bracket, a lock with lock cam pivot, the lock cam is connected with the bracket by the lock cam pivot in rotary connection. The lock cam has a latch portion, an engaging bulge and a lock groove. A biasing means is connected with the lock cam for turning the lock cam to open position. A lock bar is embed in the lock groove by a biasing force for locking the lock cam, and make the lock cam cannot be turned. A lock buckle is fixed on the door of a safekeeping box. An actuator device includes a crankshaft connected with the output shaft of a motor, a connecting rod is connected with the crank shaft in rotary connection, and one end of the lock bar is connected with the connecting rod in rotary connection. When closing door the lock buckle on the door pushes the engaging bulge to force the lock cam turn, then the latch portion of the lock cam inserts into the lock buckle to lock the door of the safekeeping box; when opening door, the motor drives the crankshaft turn to pull the connecting rod, which in turn pulls the lock bar out off the lock groove of the lock cam, then the biasing means forces the lock cam turn to let the latch portion leaving from the lock buckle, thereafter, the door is opened.

The crank shaft can be instead by a flywheel with a biasing pivot. The connecting rod can be instead by a connecting rod with a through slot.

The biasing means can be a torsion spring, which is disposed on the lock cam pivot.

The lock bar can be a torsion spring with an extended end, which is against on the circular arc side of the lock cam and embeds into the lock groove.

The lock buckle can be n shape with an empty middle portion.

The present invention has the following advantages:

A. The connecting rod style lock assembly of the present invention uses the actuator device instead of the ratch device or motor plus cord device. The actuator device is constituted by a crank shaft, a motor and a connecting rod, the structure is simple and small.

B. The size of the connecting rod style lock assembly is small, the effective inner space of the Safekeeping Box is increased.

C. The manufacture and assembly for the connecting rod style lock assembly is simple and easy, the cost for the product is reduced greatly.

D. The usage field of the connecting rod style lock assembly is wide, it can be used for electrical controlled coffers and strongboxes, can be formed a complete set with all kind of fingerprint locks.

### BRIEF DESCRIPTION OF THE DRAWINGS

FIG. 1 is a sketch figure for illustrating the structure of a lock assembly for fingerprint safekeeping box, which is a prior art.

FIG. 2 is a sketch figure for illustrating the structure of a connecting rod style lock assembly for fingerprint safekeeping box of the present invention.

FIG. 3 is a sketch figure for illustrating the assembly of shown in FIG. 2, it is in unlocked status.

FIGS. 4 and 5 are sketch figures for illustrating the working principle of the connecting rod style lock assembly for fingerprint safekeeping box of the present invention. The FIG. 4 is in unlocked status and the FIG. 5 is in locked status.

FIGS. 6 and 7 are cross section figures for illustrating the fingerprint safekeeping box fixed with the connecting rod style lock assembly of the present invention. The FIG. 6 is in locked status and the FIG. 7 is in unlocked status.

FIG. 8 is a sketch figures for illustrating the motor is controlled by an electrical controlling system.

### DETAIL DESCRIPTION OF THE INVENTION

Prior to proceeding to the much more detailed description of the present invention, it should be noted that identical components which have identical functions have been identified with identical reference numerals throughout the several views illustrated in the drawing figures, for the sake of clarity and understanding of the invention.

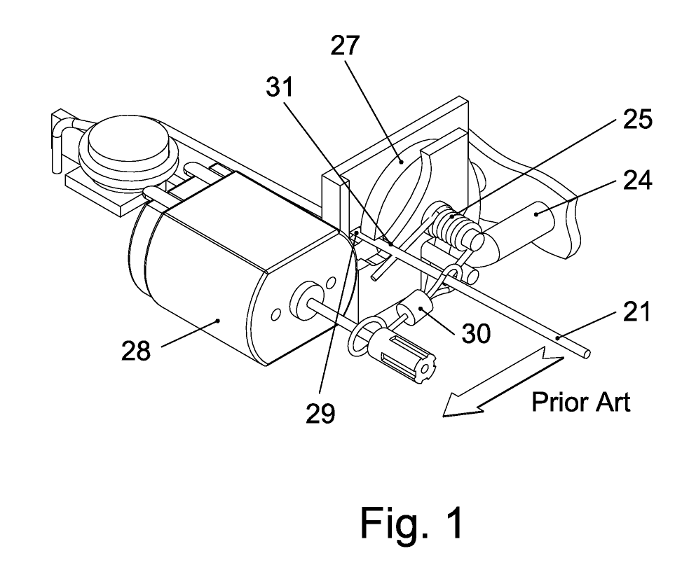

Reference is now made to FIG. 1, a lock assembly for fingerprint safekeeping box is disclosed as prior art. In which the motor 28 pulls the cord 30 then the cord 30 pulls the lock bar 21 out off the lock groove 31, thereafter the lock cam 27 is turned by the torsion spring 25 to release the lock buckle 24, and the door is opened. The cord 30 is broken easily as the cord is tired after many times of pull. Normally the cord life is about 2000 times of Pull. The cord life cannot be satisfied in the operation need for the safekeeping box. In the meantime, the motor plus cord device needs powerful motor for pulling the cord, therefore, the life of batteries for the motor is short.

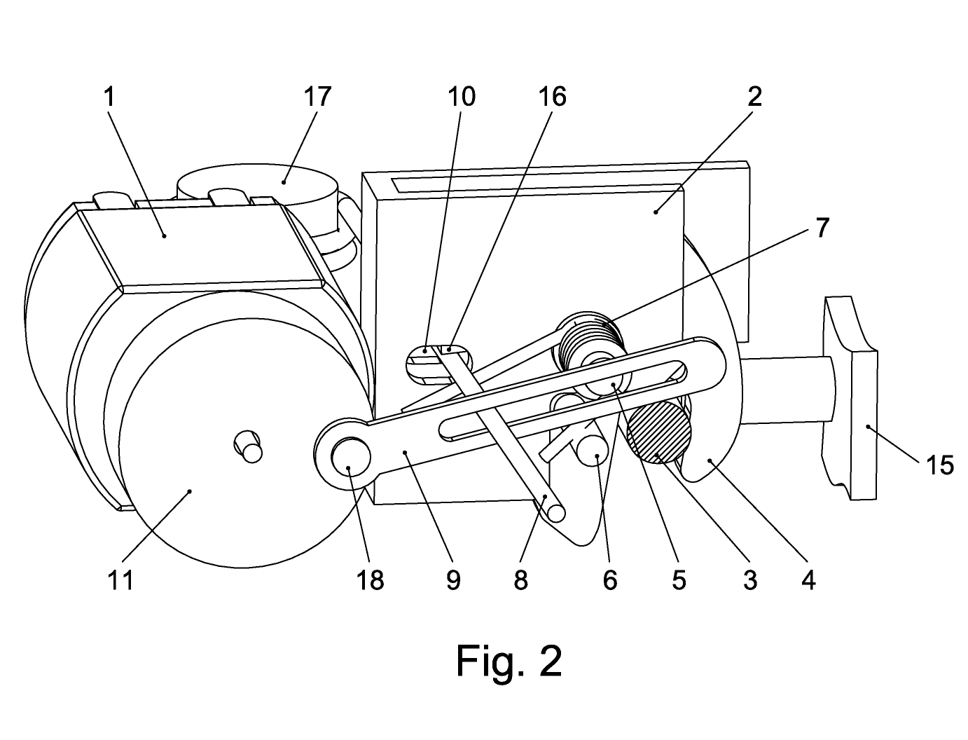

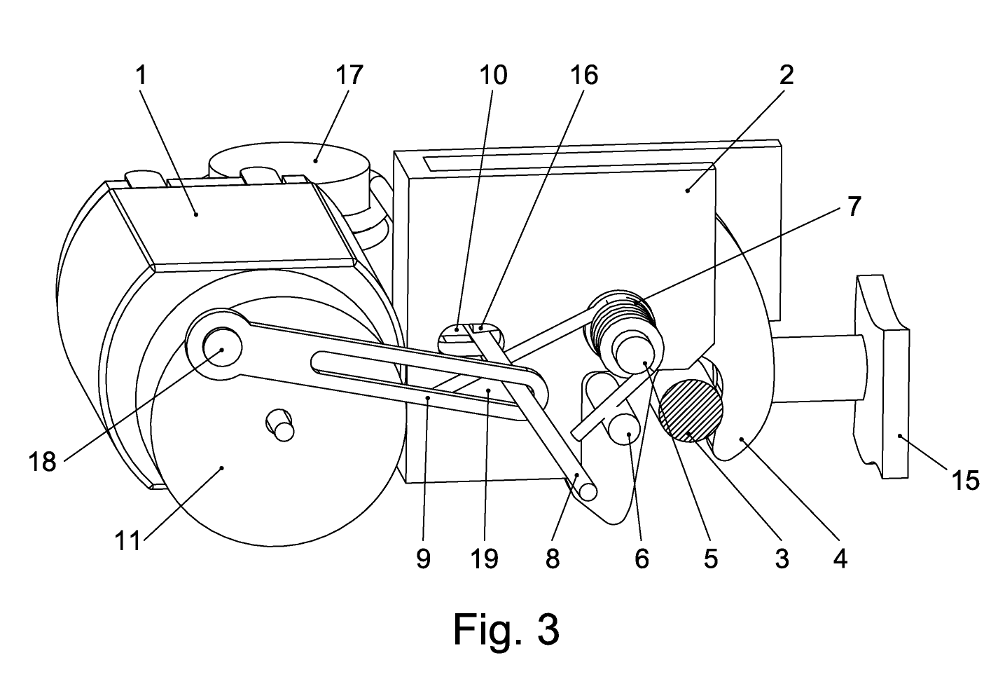

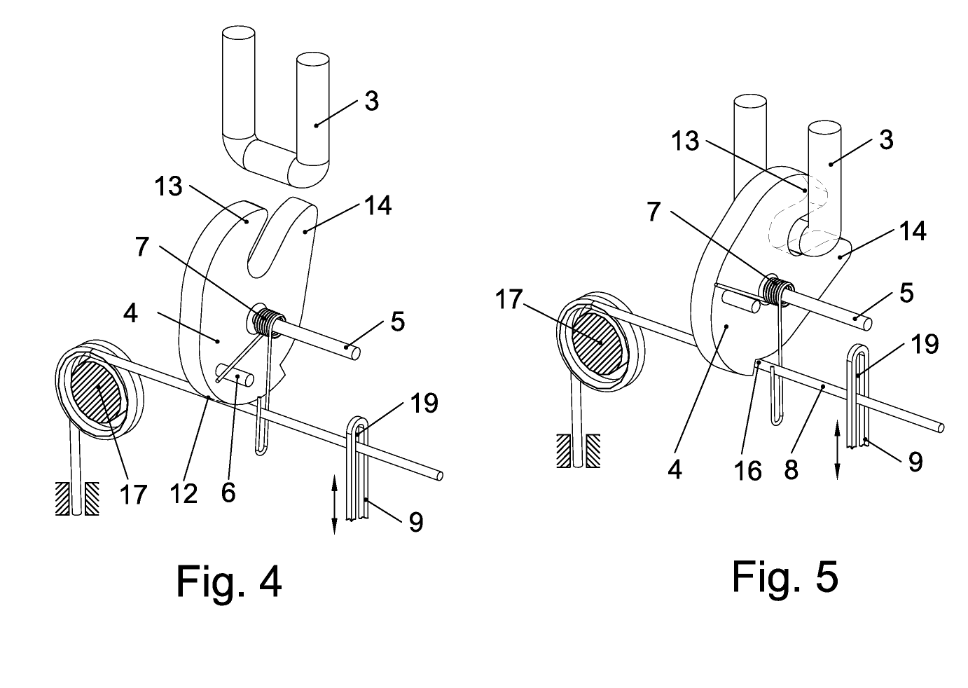

Please refer to FIGS. 2 and 3; they illustrate a connecting rod style lock assembly for fingerprint safekeeping box of the present invention. It includes a motor 1, a bracket 2, a lock buckle 3 and a lock cam 4. The motor 1 is fixed on a base beside the lock bracket 2. A rock cam 4 has a circular arc side 12 defining a latch portion 13 and an engaging bulge 14 (see FIG. 4). The rock cam 4 is connected with the lock bracket 2 by a lock cam pivot 5 in rotary connection. A lock buckle 3 is fixed on a door 15 opposite to the lock cam 4. Also, the lock cam 4 has a lock groove 16 on its side 12 and a pin 6 fixed on its body vertically at the position opposite to the lock buckle 3. A torsion spring 7 is deposited on the lock cam pivot 5, its one end is against the pin 6 and other end is against a lock bar 8, the torsion spring 7 gives an opening force to the rock cam 4. The lock bar 8 is a torsion spring with an extended end and is disposed on a lock bar pivot 17 fixed on the base. Under the biasing of the torsion spring 17, the lock bar 8 embeds into the lock groove 16 to stop the turn of the lock cam 4. The actuator device includes a motor 1, a flywheel 11 having a bias pivot 18 and a connecting rod 9. The motor 1 is fixed on the base. The flywheel 11 is fixed on the shaft of the motor 1. The connecting rod 9 having a through slot 19 is connected with the bias pivot 18 of the flywheel 11, the lock bar 8 inserts into the through slot 19 of the connecting rod 9.

Now refer to FIGS. 4 and 5. They illustrate the processes of opening and closing door of the safekeeping box:

Closing Door 15:

The lock buckle 3 pushes the engaging bulge 14 of the lock cam 4 to force the lock cam 4 turn; then the latch portion 13 of the lock cam 4 inserts into the lock buckle 3 to lock the door 15 of a safekeeping box; in the mean time the lock bar 8 moves on the side 12 of the lock cam and embeds into the lock groove 16 finally, thereby the lock cam 4 is locked and cannot be turned again.

Opening the Door 15:

After passing the fingerprint test the electric control system 31 issues an order to the motor 1, the motor 1 drives the flywheel 11 turn, then the bias pivot 18 brings the connecting rod 9 to move up and down, the end of the slop 19 of the connecting rod first leaves the lock bar 8 then return to strikes the lock bar 8 out off the lock groove 16 of the lock cam 4, then the torsion spring 7 forces the lock cam 4 turn to let the latch portion 13 leaving from the lock buckle 3, thereafter, the door 5 is opened. As the action for pulling the lock bar 8 out off the lock groove 16 is a strike, the need of motor power is reduced, therefore, a small power motor can be adopted for the assembly, and the life of batteries for the motor 1 is much extended.

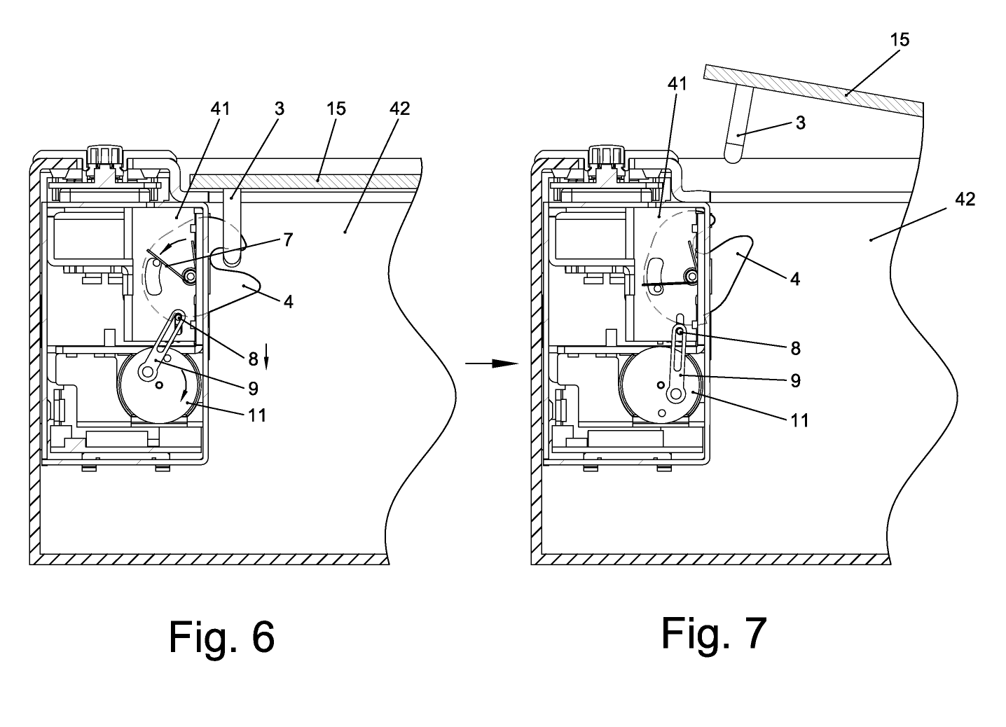

Now, refer to FIGS. 6 and 7. They illustrate the connecting rod style lock assembly 41 of the present invention is assembled in the fingerprint safekeeping box 42.

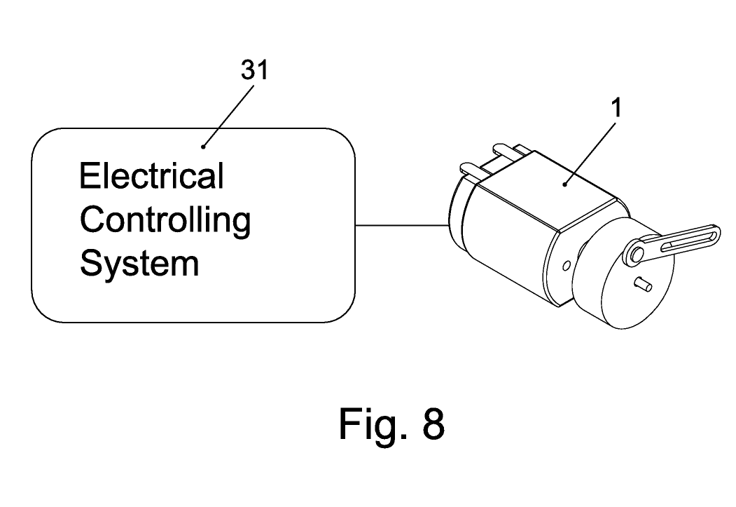

Now refer to FIG. 8. The motor 1 is controlled by an electrical controlling system 31 secured by fingerprint. After passes the test of fingerprint, the electrical system 11 issues a step moving signal to the motor 1, then the motor 1 turns a circuit then stop.

What is claimed is:

1. A connecting rod style lock assembly for fingerprint safekeeping boxes comprising:
a base, a bracket fixed on the base;
a lock buckle fixed on a door of the fingerprint safekeeping box;
a lock cam having a latch portion, an engaging bulge, a lock groove and a lock cam pivot, the lock cam being connected with the bracket in rotary connection;
a biasing means deposited on the lock cam pivot for providing a continuing turn force to the lock cam;
a lock bar having a biasing force embedding in the lock groove for locking the lock cam without turn;
an actuator device constituted by crank shaft and connecting rod, the lock bar being connected with the connecting rod in rotary connection;
an electric motor fixed on the base and being connected with the crank shaft;
When closing the fingerprint safekeeping boxes the lock buckle pushes the engaging bulge to force the lock turn, then the latch portion of the lock cam inserts into the lock buckle to lock the door, the lock bar embeds into the rock grove to lock the lock cam without turn; when opening the door, the motor drives the crankshaft turn to pull the connecting rod, which in turn pulls the lock bar out off the lock groove of the lock cam, then the biasing means forces the lock cam turn to let the latch portion leaving from the lock buckle, thereafter, the door is opened.

2. The connecting rod style lock assembly for fingerprint safekeeping boxes of claim 1, wherein the actuator device is constituted by a flywheel having a biasing pivot and a connecting rod with a through slot connected with the biasing pivot in rotary connection, the lock bar inserts into the through slot of the connecting rod.

3. The connecting rod style lock assembly for fingerprint safekeeping boxes of claim 1, wherein the biasing means is a torsion spring, which is disposed on the lock cam pivot, one end of the torsion spring is against a pin fixed on the body of the lock cam, another end is against the lock bar.

4. The connecting rod style lock assembly for fingerprint safekeeping boxes of claim 1, wherein the lock bar is a torsion spring which is disposed on a lock bar pivot fixed on the base, one end of the torsion spring inserts into the through slot of the connecting rod, another end is fixed with the bracket.

5. The connecting rod style lock assembly for fingerprint safekeeping boxes of claim 1, wherein the lock buckle has n shape.

6. The connecting rod style lock assembly for fingerprint safekeeping boxes of claim 1, wherein the motor is controlled by an electrical control system being secured by personal fingerprint.

7. The connecting rod style lock assembly for fingerprint safekeeping boxes of claim 2, wherein when the motor is turned in step, the end of the slop of the connecting slot first leaves the rock bar, then returns and moves to the rock bar rapidly, finally strikes the rock bar out off the lock groove, thereby a small power motor can be used for the assembly.

8. The connecting rod style lock assembly for fingerprint safekeeping boxes of claim 1, wherein The motor 1 is controlled by an electrical controlling system secured by fingerprint, after passing a test of fingerprint, the electrical system issues a step moving signal to the motor, then the motor turns a circuit then stop.
